(19) United States
(12) Patent Application Publication
(10) Pub. No.: US 2022/0298838 A1
(43) Pub. Date: Sep. 22, 2022

(54) COMPLIANT HINGE FOR MOTOR VEHICLE

(71) Applicant: Magna Closures Inc., Newmarket (CA)

(72) Inventor: Thomas WOOD, Newmarket (CA)

(21) Appl. No.: 17/611,953

(22) PCT Filed: May 27, 2020
(86) PCT No.: PCT/CA2020/050723

§ 371 Date: Nov. 17, 2021

Related U.S. Application Data
(60) Provisional application No. 62/854,592, filed on May 30, 2019.

(51) Int. Cl. E05F 1/12; E05D 7/00; E05D 3/02

(52) U.S. Cl. CPC E05F 1/12; E05D 7/00; E05D 3/02; E05Y 2201/47; E05Y 2900/548

(57) ABSTRACT

A hinge assembly for assisting in moving a pivotal closure member from a closed position toward an open position relative to a motor vehicle body and for releasably holding the closure member in the open position, and method of construction thereof are provided. The hinge assembly has a first mount member configured for operable connection to one of the closure member and the motor vehicle body; a second mount member configured for operable connection to the other of the closure member and the motor vehicle body; at least one linkage operably coupling the first mount member to the second mount member; and at least one elastically deformable joint coupling the at least one linkage to at least one of the first mount member and the second mount member.

### CROSS-REFERENCE TO RELATED APPLICATION

This application claims the benefit of U.S. Provisional Application Ser. No. 62/854,592, filed May 30, 2019, which is incorporated herein by reference in its entirety.

### FIELD

The present disclosure relates generally to closure panel hinges in motor vehicles. More particularly, the present disclosure is directed to a non-power-operated hinge assembly having a resilient member operable to assist in opening and holding a motor vehicle closure panel in an open position.

### BACKGROUND

This section provides background information which is not necessarily prior art to the inventive concepts associated with the present disclosure.

Motor vehicle closure panels, such as lift gates, deck lids (trunk lids) and front hoods, are typically hingedly connected to a vehicle body member for pivotal movement between open and closed positions. To facilitate movement of the closure panel from a closed position to an open position, it is known to incorporated power-assisted, electromechanical mechanisms, such as a powered strut, into the closure panel assembly. The power-assisted mechanisms are useful to assist in opening the vehicle closure panel; however, they are generally complex to manufacture and assemble, and thus, costly.

Efforts to reduce cost include providing non-powered pneumatic struts and/or coil spring biased struts; however, although less costly than electromechanical mechanisms, they still can be relatively costly in manufacture and assembly.

While electromechanical struts, non-powered pneumatic struts and coil spring biased struts currently used in closure panel systems provide desired assistance in opening and holding closure panels in an open position, a need exists to continue development of improved hinge mechanisms which obviate or mitigate one or more of the shortcomings associated with prior art hinges, powered strut mechanism and non-powered strut mechanisms.

### SUMMARY

This section provides a general summary of the disclosure and is not a comprehensive disclosure of its full scope or all of its features, aspects or objectives.

It is an aspect of the present disclosure to provide a non-powered, compliant, resilient hinge assembly for use with closure panel in a motor vehicle that overcomes at least some of the drawbacks discussed above for known power-assisted, electromechanical mechanisms and non-power-assisted mechanisms.

It is a related aspect of the present disclosure to provide a non-powered, compliant, resilient hinge assembly for use with closure panel in a motor vehicle for assisting in the movement of the closure panel from a closed position toward an open position relative to a motor vehicle body.

It is a related aspect of the present disclosure to provide a non-powered, compliant, resilient hinge assembly for use with closure panel in a motor vehicle for assisting in releasably holding the closure panel in the open position.

It is a further related aspect of the present disclosure to provide a non-powered, compliant, resilient hinge assembly that is economical in manufacture, assembly and in use.

It is a further aspect of the present disclosure to provide such a non-powered, compliant, resilient hinge assembly having a hinge region formed as a monolithic piece of elastomeric material.

It is a further aspect of the present disclosure to provide such a hinge region having an unbiased, energy-exhausted position corresponding to an open position of the closure panel and a biased, energy-stored position corresponding to a closed position of the closure panel.

In accordance with these and other aspects, the present disclosure is directed to a hinge assembly for assisting in moving a pivotal closure member from a closed position toward an open position relative to a motor vehicle body and for releasably holding the closure member in the open position, including the following: a first mount member configured for operable connection to one of the closure member and the motor vehicle body; a second mount member configured for operable connection to the other of the closure member and the motor vehicle body; at least one linkage operably coupling the first mount member to the second mount member; and at least one elastically deformable joint coupling the at least one linkage to at least one of the first mount member and the second mount member.

In accordance with another aspect of the disclosure, the at least one elastically deformable joint is a monolithic piece of material with the linkage and at least one of the first mount member and the second mount member.

In accordance with another aspect of the disclosure, the at least one elastically deformable joint includes a first elastically deformable joint formed as a monolithic piece of material with the linkage and the first mount member and a second elastically deformable joint formed as a monolithic piece of material with the linkage and the second mount member.

In accordance with another aspect of the disclosure, the at least one elastically deformable joint is a polymeric material.

In accordance with another aspect of the disclosure, the at least one elastically deformable joint includes a plurality of elastically deformable members spaced from one another, each elastically deformable member having a linkage end fixed to the linkage and a mount end fixed to one of the first mount member and the second mount member.

In accordance with another aspect of the disclosure, the plurality of elastically deformable members converge from the mount ends toward one another to the linkage ends.

In accordance with another aspect of the disclosure, the at least one linkage includes a first linkage operably coupling the first mount member to the second mount member and a second linkage operably coupling the first mount member to the second mount member, at least one of the first linkage and the second linkage including the at least one elastically deformable joint.

In accordance with another aspect of the disclosure, the first linkage and the second linkage includes at least one of the elastically deformable joint.

In accordance with another aspect of the disclosure, at least one of the first linkage and the second linkage includes a first elastically deformable joint formed as a monolithic piece of material with the linkage and the first mount member and a second elastically deformable joint formed as a monolithic piece of material with the linkage and the second mount member.

In accordance with another aspect of the disclosure, the first elastically deformable joint includes a plurality of first elastically deformable members spaced from one another, each first elastically deformable member having a first linkage end fixed to the at least one first linkage and the second linkage and a first mount end fixed to the first mount member and the second elastically deformable joint includes a plurality of second elastically deformable members spaced from one another, each second elastically deformable member having a second linkage end fixed to the at least one first linkage and the second linkage and a second mount end fixed to the second mount member.

In accordance with another aspect of the disclosure, the plurality of first elastically deformable members converge from the first mount ends toward one another to the first linkage ends and the plurality of second elastically deformable members converge from the second mount ends toward one another to the second linkage ends.

In accordance with another aspect of the disclosure, at least one of the first linkage and the second linkage includes a pivotable joint connection to at least one of the first mount member and the second mount member.

In accordance with another aspect of the disclosure, the pivotable joint connection is provided by a convex surface on at least one of the first linkage and the second linkage engaging a concave surface on at least one of the first mount member and the second mount member.

In accordance with another aspect of the disclosure, further including at least one biasing member extending from at least one of the first mount member and the second mount member, the at least one biasing member engaging at least one of the first linkage and the second linkage to bias the closure member from the closed position toward the open position.

In accordance with another aspect of the disclosure, a method of constructing a hinge assembly for assisting in moving a pivotal closure member from a closed position toward an open position relative to a motor vehicle body and for releasably holding the closure member in the open position is provided. The method includes the following steps: forming a first mount member configured for operable connection to one of the closure member and the motor vehicle body; forming a second mount member configured for operable connection to the other of the closure member and the motor vehicle body; operably coupling the first mount member to the second mount member with at least one linkage; and molding at least one elastically deformable joint coupling the at least one linkage to at least one of the first mount member and the second mount member.

In accordance with another aspect of the disclosure, the method can further include molding the at least one elastically deformable joint as a monolithic piece of material with the linkage and at least one of the first mount member and the second mount member.

In accordance with another aspect of the disclosure, the method can further include molding the linkage and the at least one elastically deformable joint including a first elastically deformable joint formed as a monolithic piece of material with the linkage and the first mount member and a second elastically deformable joint formed as a monolithic piece of material with the linkage and the second mount member.

In accordance with another aspect of the disclosure, the method can further include molding the first elastically deformable joint and the second elastically deformable joint having a plurality of elastically deformable members spaced from one another, each elastically deformable member having a linkage end fixed to the linkage and a mount end fixed to one of the first mount member and the second mount member.

In accordance with another aspect of the disclosure, the method can further include operably coupling the first mount member to the second mount member with a plurality of the at least one linkage.

In accordance with another aspect of the disclosure, the method can further include molding each of the plurality of linkages as a monolithic piece of material with a separate one of the at least one elastically deformable joint and molding the elastomeric deformable joints as a monolithic piece of material with at least one of the first mount member and the second mount member.

Further aspects and areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the written description when considered in combination with the appended Figures, wherein:

FIG. 1 is a side view of a motor vehicle having a closure panel equipped with a hinge assembly constructed in accordance with the teachings of the present disclosure;

FIG. 1A is a view similar to FIG. 1 illustrating the closure panel moved to an open position with the hinge assembly releasably holding the closure panel in the open position;

FIG. 2 is a perspective view of a hinge assembly releasably constructed in accordance with one aspect of the disclosure;

FIG. 3 is a side view of the hinge assembly shown in FIG. 2 shown supporting a closure panel in a closed position;

FIG. 3A is an enlarged view of a portion of the hinge assembly while in the closed position as shown in FIG. 3;

FIG. 4 is a side view of the hinge assembly shown in FIG. 2 shown supporting a closure panel in a neutral open position;

FIG. 4A is an enlarged view of a portion of the hinge assembly while in the neutral open position as shown in FIG. 4;

FIG. 5 is a side view of the hinge assembly shown in FIG. 2 shown supporting a closure panel in a fully open position;

FIG. 5A is an enlarged view of a portion of the hinge assembly while in the fully open position as shown in FIG. 5;

FIG. 6 is a view similar to FIG. 4 illustrating a hinge assembly constructed in accordance with another aspect of the disclosure releasably shown holding a closure panel in a neutral open position;

FIG. 7 is a view similar to FIG. 4 illustrating a hinge assembly constructed in accordance with another aspect of the disclosure releasably shown holding a closure panel in a neutral open position; and

FIG. 8 is a flow diagram illustrating a method of constructing a hinge assembly for a motor vehicle closure panel in accordance with another aspect of the disclosure.

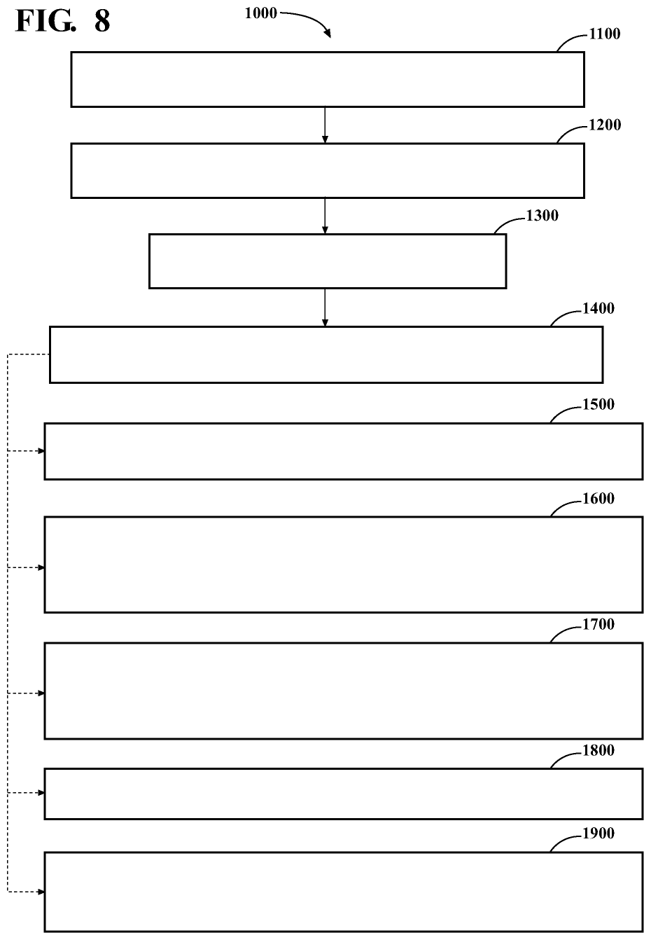

### DETAILED DESCRIPTION OF EXAMPLE EMBODIMENTS

Motor vehicles are equipped with numerous moveable closure panels for providing openings and access within and through defined portions of the vehicle body. To enhance operator convenience, many vehicles are now equipped with assist mechanisms to control movement of all types of closure panels including, without limitation, hatch lift gates, trunk deck lids, front hoods, sliding and hinged doors, sun roofs and the like. Current development focus is largely directed to improving these assist mechanisms through weight and part count reduction, packaging efficiency, system noise, back drive effort, cost and ease of assembly and service repair. Accordingly, the present disclosure addresses all of these issues.

For purposes of descriptive clarity, the present disclosure is described herein in the context of one or more specific vehicular applications, namely hinge assemblies for closure panels, illustrated herein as a deck lid (trunk closure panel). However, upon reading the following detailed description in conjunction with the appended drawings, it will be clear that the inventive concepts of the present disclosure can be applied to numerous other closure panels. In this regard, the present disclosure is generally directed to hinge assemblies for pivotably coupling a closure panel to a vehicle body member. Specifically, the hinge assembly is operatively coupled between a closure panel and a body member to facilitate pivotal movement of the closure panel between a closed position and an open position, and to releasably hold the closure panel in an open position until desired to return the closure panel to the closed position. Finally, the present disclosure is also directed to a method of constructing a hinge assembly in economical fashion, wherein the hinge assembly has a minimum number of separable components and is easy and economical to assemble.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

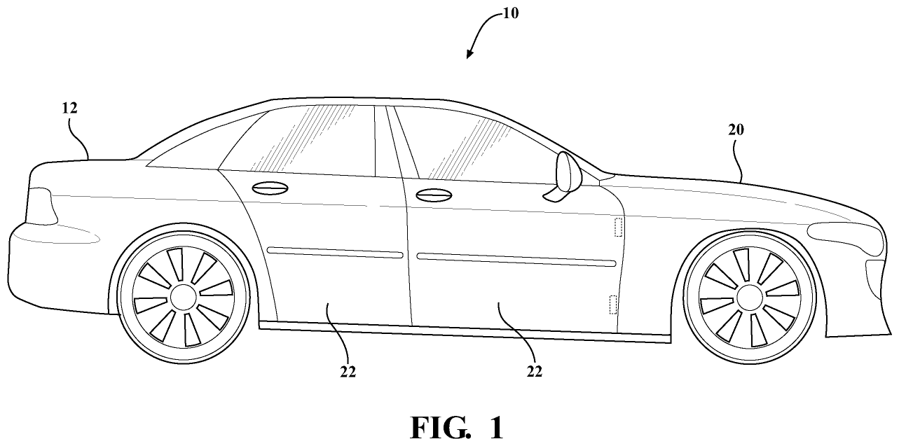

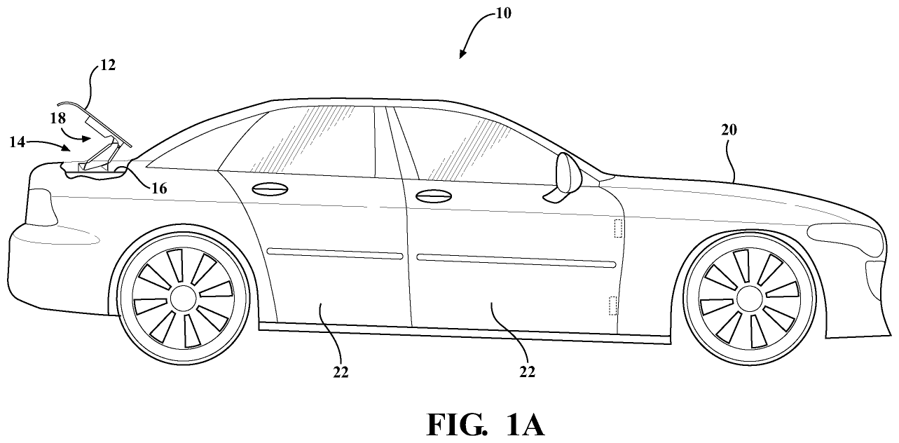

Reference is now made to FIG. 1, which shows a motor vehicle 10 that has a plurality of pivotal closure members, with specific reference being directed to a trunk lid, also referred to as deck lid 12, by way of example and without limitation. Deck lid 12 encloses a trunk 14 typically used for storage. Referring to FIG. 1A, the deck lid 12 is pivotably coupled to a vehicle body member, also referred to as motor vehicle body, frame or support member 16, by a hinge assembly 18 to allow deck lid 12 to be pivoted from a closed position (FIG. 1) to an open position (FIG. 1A) to provide access to the stowage space provided by trunk 14. Hinge assembly 18, although shown in a deck lid application, could be incorporated for use in a front hood application to facilitate pivotal movement of a front hood 20, and/or in a swing door application to facilitate pivotal movement of a swing door 22, by way of example and without limitation. Hinge assembly 18 is constructed to assist in moving deck lid 12 from the closed position toward the open position and to releasably holding the deck lid 12 in the open position, until desired to return deck lid 12 to its closed position, as discussed in more detail below. Hinge assembly is economical in manufacture and assembly, is lightweight and has a minimal number of separate components, thereby making hinge assembly economical in use and relatively low in cost.

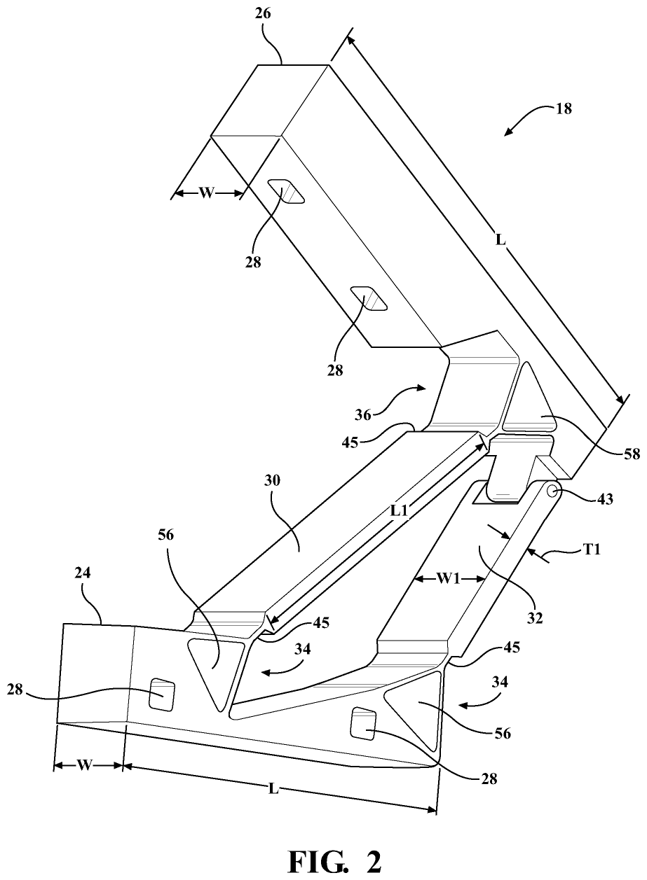

Hinge assembly 18 includes a first mount member 24 configured for operable connection to one of the closure member 12 and the motor vehicle body 16, and shown as the closure member 12, and a second mount member 26 configured for operable connection to the other of the closure member 12 and the motor vehicle body 16, and shown as the motor vehicle body (support member) 16. First mount member 24 and second mount member 26 can be configured (shaped, countered, sized) as desired to facilitate attachment to the respective closure member 12 and motor vehicle body 16, such as via mechanical fasteners, including screws, bolts, rivets and the like (not shown), extending through fastener openings 28 formed through the first and second mount members 24, 26. Fastener openings 28 can be reinforced with metal anti-crush members, such as metal tube inserts, if desired, thereby providing increased crush resistance upon tightening the fasteners. As shown in FIG. 2, first mount member 24 and second mount member 26 are shown as being generally rectangular prisms, having a length (L) extending between opposite ends, a width (W) extending across opposite sides and a height extending between a mount surface 25 and joint attachment surface 27. Mount surface 25 is shown as being flat and planar for engagement with a flat, planar surface of respective support member 16 and deck lid 12, though it could be contoured otherwise. Joint attachment surface 27 is contoured having an surface extending in oblique relation to mount surface 25, for reasons discussed hereafter. Hinge assembly 18 further includes at least one linkage, and shown as a plurality of linkages, referred to hereafter as a first linkage 30 and a second linkage 32, operably coupling the first mount member 24 to the second mount member 26. First linkage 30 and a second linkage 32 are shown as being generally flat, planar, rectangular prism members, having a width W1 equal or substantially to the width W of the first and second mount members 24, 26, a length L1 provided as desired to provide the desire range of pivotal movement of first and second mount members 24, 26 relative to one another, and a thickness T1 suitable to inhibit significant bending and flexing of the first and second linkages 30, 32, thereby rendering the first and second linkages 30, 32 being relatively stiff. It is to be recognized that the aforementioned dimensions of the width, length and thickness of the first and second linkages 30, 32 could be varied as desired, depending on the application requirements and size/weight of the closure panel 12. Hinge assembly 18 further includes at least one elastically deformable joint, and shown as a plurality of elastically deformable joints. The elastically deformable joints are referred to hereafter as first elastically deformable joints 34 and second elastically deformable joints 36. The first elastically deformable joints 34 are shown as coupling the first linkage 30 and the second linkage 32 to at least one of the first mount member 24 and the second mount member 26, and shown as to the joint attachment surface 27 of the first mount member 24. The second elastically deformable joint 36 is shown coupling the first linkage 30 to at least one of the first mount member 24 and the second mount member 26, and shown as to the joint attachment surface 27 of the second mount member 26. Accordingly, the first linkage 30 is operably connected at opposite ends to the first mount member 24 and the second mount member 26 via respective first elastically deformable joint 34 and second elastically deformable joint 36. Meanwhile, in the non-limiting embodiment, the second linkage 32, spaced from first linkage 30, is operably connected at one end to joint attachment surface 27 of the first mount member 24 via first elastically deformable joint 34, while an opposite end of second linkage 32, by way of example and without limitation, is operably connected to second mount member 26 via a pivotable joint 38, shown as including a dowel or pin connection including a pin 40 disposed in respective through openings 42, 43 of second linkage 32 and second mount member 26. Pivotable joint 38 allows unbiased, unencumbered pivotable movement of second linkage 32 relative to second mount member 26. First linkage 30 and second linkage 32 are thus arranged in a four-bar linkage configuration.

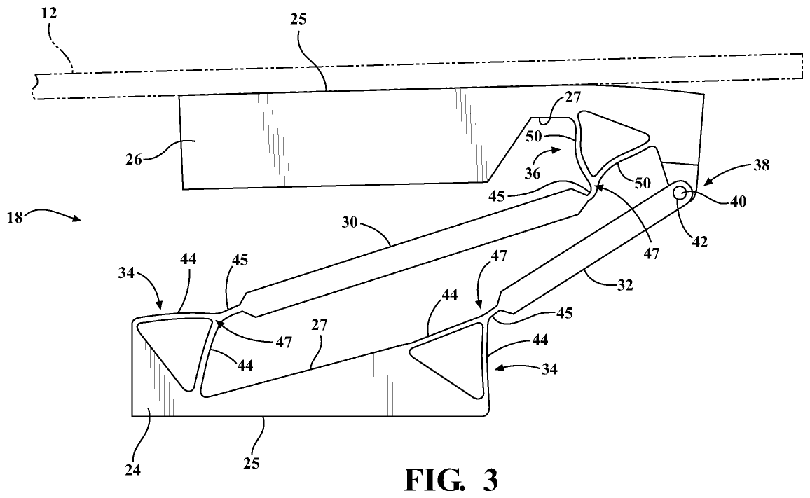

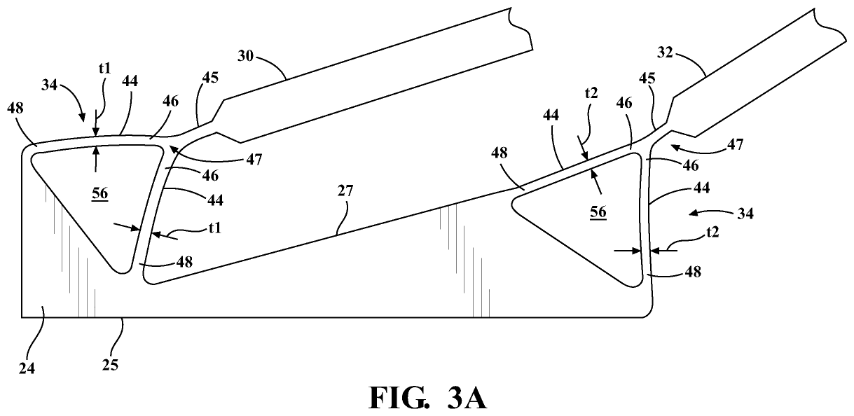

In a preferred embodiment, to enhance the economies of manufacture and assembly, the elastically deformable joint 34, 36 is constructed as a monolithic piece of material with the linkage 30, 32 and at least one of the first mount member 24 and the second mount member 26. In the non-limiting embodiment shown in FIGS. 3-5, the first linkage 30 is formed as a monolithic piece of material with the first elastically deformable joint 34 and the second elastically deformable joint 36, and the first elastically deformable joint 34 is formed as a monolithic piece of material with the first mount member 24 and the second elastically formable joint 36 is formed as a monolithic piece of material with the second mount member 26. Accordingly, the first mount member 24 and the second mount member 26 are inseparable from one another.

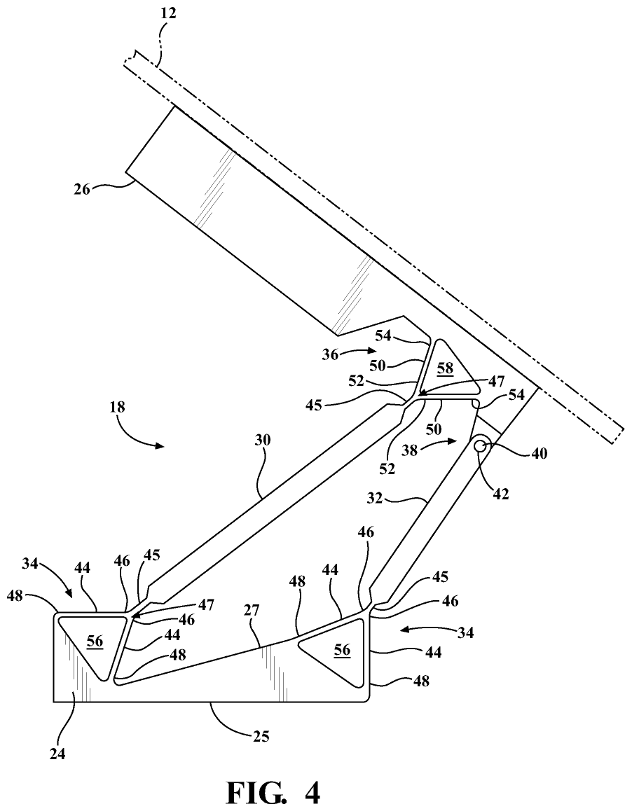

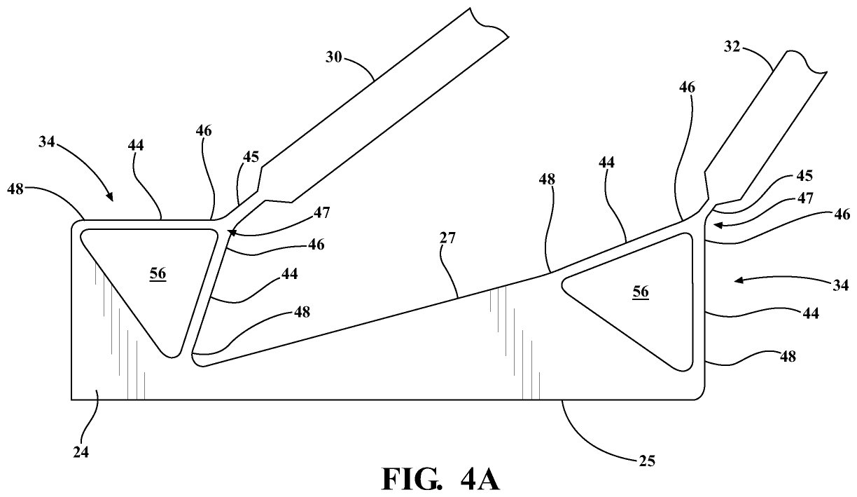

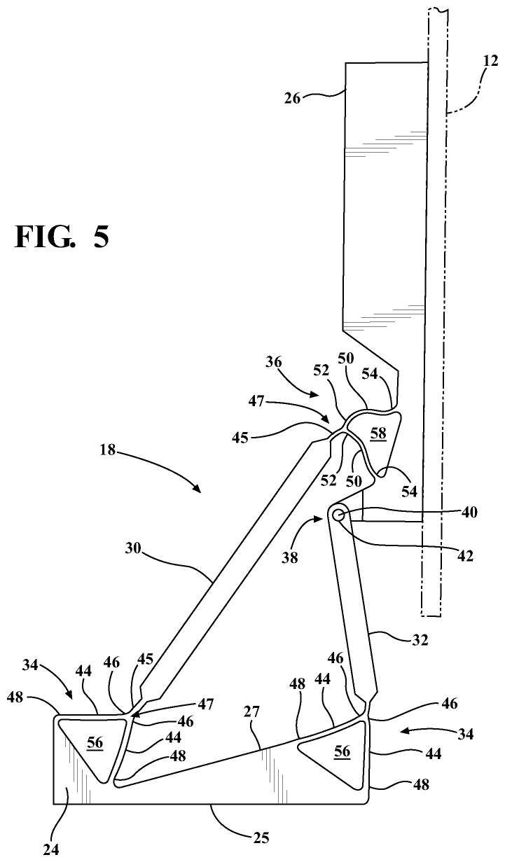

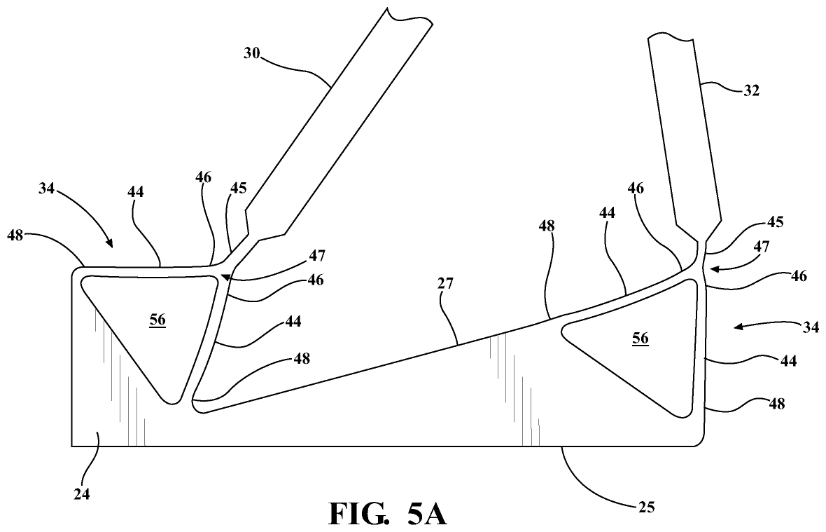

To enhance flexibility, economies of manufacture and the ability to provided integral spring biased assistance of movement of the closure panel 12 from the closed position to the open position, the monolithic hinge assembly 18 can be molded from a resilient polymeric material. Any suitable durable, resilient, compliant polymeric material can be used, including various types of rubber, reinforced rubber, thermoplastic elastomers (TPE), PA66 (Nylon), polyethylene terephthalate (PET), and the like. The molding process simplifies construction, while minimizing time and capital equipment need to make the hinge assembly 18, as will be appreciated by one possessing ordinary skill in the art. In accordance with one aspect, the hinge assembly 18 can be molded so that when the deck lid 12 is supported in the open, neutral position, as shown in FIGS. 1A, 4 and 4A, the hinge assembly 18 is in its relaxed, unbiased, energy depleted configuration. As such, when the deck lid 12 is in its closed position, as shown in FIGS. 1 and 3, the hinge assembly 18 is in a biased, energy storing configuration, such that upon unlatching the deck lid 12, the hinge assembly 18 automatically assists in moving the deck lid 12 toward its open, neutral position via the bias imparted by the hinge assembly 18 on the deck lid 12. With the hinge assembly 18 being flexible, resilient and compliant, if it is desired to move the deck lid 12 to a fully open position (FIG. 5) beyond the open, neutral position, the hinge assembly 18 can be flexed beyond the relaxed, unbiased state without damaging the hinge assembly 18, as facilitated by the pivotable joint 38 allowing unencumbered pivoting movement of the second linkage 32 over-center and by the flexing of the second elastically deformable joint 36.

To enhance the flexibility, the first elastically deformable joint 34 includes a plurality of first elastically deformable members 44 spaced from one another. The first elastically deformable members 44 can be formed as generally planar members extending over a width corresponding to a width of the generally planar first linkage 30 and a width of the first mount member 24. Each first elastically deformable member 44 has a first linkage end 46 fixed to the first linkage 30 and the second linkage 32 and a first mount end 48 fixed to the first mount member 24. The second elastically deformable joint 36 includes a plurality of second elastically deformable members 50 spaced from one another. The second elastically deformable members 50 can be formed as generally planar members extending over a width corresponding to a width of the generally planar first linkage 30 and a width of the second mount member 26. Each second elastically deformable member 50 has a second linkage end 52 fixed to the first linkage 30 and a second mount end 54 fixed to the second mount member 26. The plurality of first elastically deformable members 44 of each first elastically deformable joint 34 converge from the first mount ends 48 toward one another to the first linkage ends 46 and the plurality of second elastically deformable members 50 of each second elastically deformable joint 36 converge from the second mount ends 54 toward one another to the second linkage ends 52. Accordingly, with the first and second elastically formable joints 34, 36 in their relaxed states, the first and second elastically formable joints 34, 36 are triangular, as viewed in the side views illustrated, with the first elastically formable joints 34 having an elongate hollow chamber 56 bounded by the first elastically deformable members 44 and first mount member 24 and with the second elastically formable joints 36 having an elongate hollow chamber 58 bounded by the second elastically deformable members 50 and second mount member 26 across the width W of the joints 34, 36. First and second elastically formable joints 34, 36 may further include a projecting elastically deformable member 45 extending from the apex 47 of each triangular first and second elastically formable joints 34, 36 for connection to first linkage 30. Elastically deformable members 45 provides additional flexibility to first and second elastically formable joints 34, 36 for a given range of motion at positions between open and closed positions as well as at the closed (FIG. 3) and opened positions (FIG. 5). Member 45 may be relatively thicker compared to members 44 since the range of motion of member 45 is reduced. The bulk of deformation of joints 34, 36 allowed by the relatively thin members 44. The rotation axis of joints 34, 36 are stabilized by the relative thicknesses of members 44, 45, and 30, to provide an axis of pivoting of joints 34, 36 that does not shift or change during flexing or deformation thereof. Opening/closing motion of decklid 12 is therefore consistent. A composite compliant joint in accordance with a possible configuration is therefore provided combining a multi-member flexible joint for providing stability and flexibility over the majority of the range of motion of the deck lid 12 and a single linkage flexible joint for providing additional range of motion to the multi-linkage flexible joint is provided. Single linkage flexible joint 45 is shown in a non-deformed state in FIG. 4 illustrating elastically but are configured to allow some deformation during deformation of first and second elastically formable joints 34, 36. In another configuration, single linkage flexible joint 45 may be configured to allow some deformation after deformation of first and second elastically formable joints 34, 36 or single linkage flexible joint 45 may be configured to allow some deformation after deformation of first and second elastically formable joints 34, 36 depending on the thickness of single linkage flexible joint 45 as desired.

As best shown in FIGS. 3A, 4A and 5A, the first elastically deformable members 44 coupling the first linkage 30 to the first mount member 24 can be formed having a first thickness t1 and the first elastically deformable members 44 coupling the second linkage 32 to the first mount member 24 can be formed having a second thickness t2, wherein the first thickness t1 and the second thickness t2 are different. In the non-limiting embodiment, the thickness t1 is greater than the thickness t2, such that the thickness t2 provides increased flexibility and decreased stiffness relative to thickness t1. It is to be recognized that the relative thicknesses t1, t2 can be customized for the intended application, as desired.

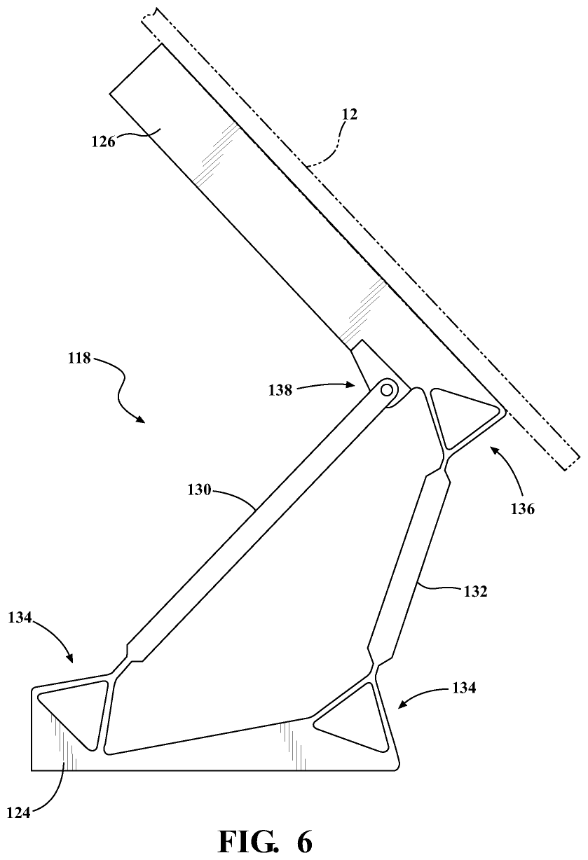

In FIG. 6, a hinge assembly 118 constructed in accordance with another aspect of the disclosure is shown, wherein like reference numerals, offset by a factor of 100, are used to identify like features as discussed above.

Hinge assembly 118 is similar to the hinge assembly 18 discussed above, being attached to deck lid 12 to support deck lid 12 for pivotal movement between a closed position, similar as shown in FIG. 3, a neutral open position, as shown in FIG. 6, and a fully open position, similar as shown in FIG. 5. Hinge assembly 118 has a first linkage 130 and a second linkage 132, both operably coupling a first mount member 124 to a second mount member 126. The first linkage 130 is coupled for hinged movement relative to first mount member 124 via a first elastically deformable joint 134, wherein first elastically deformable joint 134 is formed as a monolithic piece of molded material with first mount member 124 as discussed above for first linkage 30; however, first linkage 130 is coupled for pure pivotal movement to second mount member 126 via a pivotable joint 138, wherein pivotable joint 138 is the same as discussed above for pivotable joint 38. The second linkage 132 is coupled for hinged movement relative to first mount member 124 via a first elastically deformable joint 134 as discussed above for second linkage 32, wherein first elastically deformable joint 134 is formed as a monolithic piece of molded material with first mount member 124; however, second linkage 132 is coupled for hinged movement to second mount member 126 via a second elastically deformable joint 136, wherein second elastically deformable joint 136 is formed as a monolithic piece of molded material with second mount member 126 same as discussed above for second elastically deformable joint 36. Otherwise, hinge assembly 118 is the same as discussed above for hinge assembly 18, and thus, no further discussion is believed necessary.

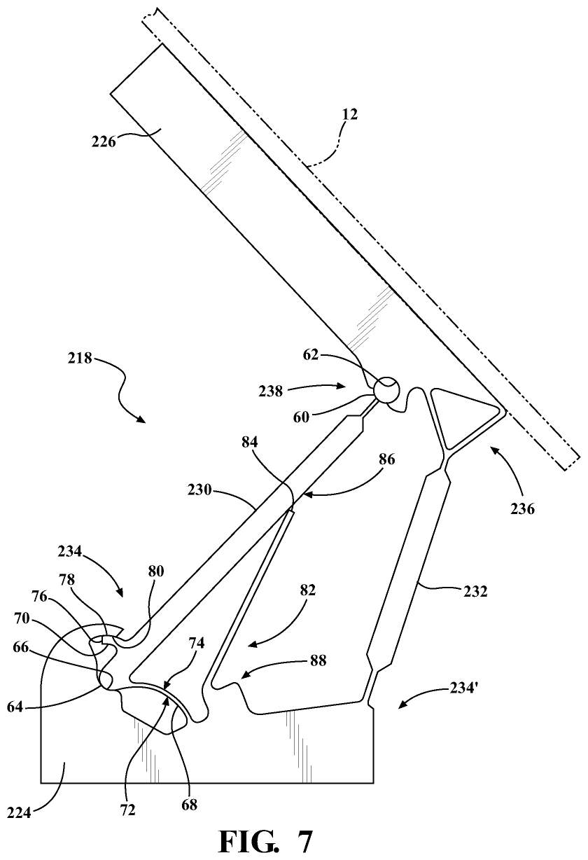

In FIG. 7, a hinge assembly 218 constructed in accordance with another aspect of the disclosure is shown, wherein like reference numerals, offset by a factor of 200, are used to identify like features as discussed above.

Hinge assembly 218 is similar to the hinge assembly 18 discussed above, being attached to deck lid 12 to support deck lid 12 for pivotal movement between a closed position, similar as shown in FIG. 3, a neutral open position, as shown in FIG. 7, and a fully open position, similar as shown in FIG. 5. Hinge assembly 218 has a first linkage 230 and a second linkage 232, both operably coupling a first mount member 224 to a second mount member 226. The first linkage 230 is coupled for hinged movement relative to first mount member 224 via a first elastically deformable joint 234 formed as a monolithic piece of molded material with first mount member 124, such as discussed above for first linkage 30; however, first elastically deformable joint 234 is configured differently than discussed above for first elastically deformed joint 34, as discussed hereafter. First linkage 230 is also coupled for pure pivotal movement to second mount member 226 via a pivotable joint 238, wherein pivotable joint 238, rather than being constructed have a pin/dowel connection as discussed above for pivotable joint 38, has a ball or cylinder and socket configuration, such that a ball or cylinder 60, formed as a monolithic piece of material with first linkage 230, is received, such as in a snap fit arrangement, in a corresponding spherical-shaped or cylindrical-shaped female socket, also referred to as cavity 62. It is to be recognized that the orientation of the ball or cylinder 60 and the socket 62 can be reversed, such that the socket 62 is formed as a monolithic piece of material with the first linkage 230. Regardless, the pivotable joint connection 238 is provided by a convex surface (ball or cylinder) on at least one of the first linkage 230 or second mount member 226 engaging a concave surface (socket 62) on the other of the first linkage 230 or second mount member 226.

The second linkage 232 is coupled for hinged movement relative to first mount member 224 via a first elastically deformable joint 234′ as discussed above for second linkage 32; however, first elastically deformable joint 234′ is configured differently than discussed above for first elastically deformed joint 34 of second linkage 32, as discussed hereafter. Second linkage 232 is coupled for hinged movement to second mount member 226 via a second elastically deformable joint 236, wherein second elastically deformable joint 236 is the same as discussed above for second elastically deformable joint 136.

First elastically deformable joint 234 of first linkage 230 is provided in part by a rounded, semi-cylindrical, convex end 64 of first linkage 230 being disposed in an elongate concave pocket 66 extending across a width of first mount member 224 for pivotal movement there against to provide a rolling pivotal motion, thereby being suitable for large compressive loads. First elastically deformable joint 234 also has a plurality, shown as a pair, of spring members, referred to as first spring member 68 and second spring member 70, to facilitate biasing movement of hinge assembly 218 from its closed position (similar to that shown in FIG. 3) to its neutral, open position (FIG. 7). First spring member 68 is formed as a monolithic piece of material with first mount member 224. First spring member 68 is formed as a bow-shaped, arcuate wall extending along the width of the first mount member 224 and along the width of the first spring member 68. First spring member 68 has a concave surface 72 facing the first mount member 224 and a convex surface 74 facing away from the first mount member 224 toward the second mount member 226. As second mount member 226 pivots from the closed position toward the neutral position (FIG. 6) and the fully open position (similar to that shown in FIG. 5), the radii of concave and convex surfaces 72, 74 increases. Accordingly, when second mount member 226 is in the closed position, the radii are reduce, thereby imparting a compressed, stressed bias in the first spring member 68, wherein the bias ultimately assists in moving second mount member 224, and deck lid 12 fixed thereto, toward the neutral, open position upon releasing a corresponding latch (not shown).

First elastically deformable joint 234′ is formed as a monolithic piece of material with first mount member 224 and second linkage 232. First elastically deformable member 234′ is formed as a single planar wall, extending along a width of the planar second linkage 232, and can be formed as a relative thin film, such as may be preferred for a lightweight deck lid 12. As such, first elastically deformable joint 234′ functions as a living hinge type joint, with the amount of bias imparted by first elastically deformable joint 234′ being controllable by the thickness of the planar wall.

Second spring member 70 extends from an opposite side of first linkage 230 from first spring member 68. Second spring member extends in cantilevered, arcuate fashion from first linkage 230 to a free end 76. Second spring member 70, being arcuate, has an upper convex surface 78 configured to slide along a mating concave surface 80 of first mount member 224 during movement of second mount member 226 between the closed and open positions. Second spring member 70 has a length extending outwardly from first linkage 230 to free end 76, wherein the length is sufficient to maintain the convex surface 78 in engagement with the concave surface 80 while the second mount member 226 and deck lid 12 are in the fully closed and open positions.

Hinge assembly 218 has at least one biasing member 82 extending from at least one of the first mount member 224 and the second mount member 226, and shown, by way of example and without limitation, as the first mount member 224. The biasing member 82 engages at least one of the first linkage 230 and the second linkage 232, and shown, by way of example and without limitation, as the first linkage 230, to bias the second mount member 226 and deck lid 12 fixed thereto from the closed position toward the open position. Biasing member 82 is shown formed as a monolithic piece of material with the first mount member 224, extending as a planer wall upwardly from an upper surface of first mount member 224 to a cantilevered free end 84. Biasing member 82 is formed to exert an upward pushing bias on an underside 86 of the wall of first linkage 230, with the bias being increased while the deck lid 12 is in the closed position. Accordingly, upon release of the latch maintaining deck lid 12 in the closed position, the biasing member 82 tends to push first linkage 230 upwardly in combination with the bias imparted by first spring member 68. The bias imparted in the biasing member 82 while the deck lid 12 is in the closed position can be controlled during the construction of hinge assembly 218 by controlling the angle as which the biasing member 82 extends from first mount member 224 during molding, and by controlling the thickness of biasing member 82 along a joint region 88 where biasing member 82 extends from first mount member 224 and by controlling the thickness and material properties of the planar wall forming biasing member 82.

In accordance with another aspect of the disclosure, a method 1000 of constructing a hinge assembly 18, 118, 218 for assisting in moving a pivotal closure member 12 from a closed position toward an open position relative to a motor vehicle body 16 and for releasably holding the closure member 12 in the open position is provided. The method 1000 includes: a step 1100 of forming a first mount member 24, 124, 224 configured for operable connection to one of the closure member 12 and the motor vehicle body 16; a step 1200 of forming a second mount member 26, 126, 226 configured for operable connection to the other of the closure member 12 and the motor vehicle body 16; a step 1300 of operably coupling the first mount member 24, 124, 224 to the second mount member 26, 126, 226 with at least one linkage 30, 32; 130, 132; 230, 232; and a step 1400 of molding at least one elastically deformable joint 34, 36; 134, 136; 234, 236 coupling the at least one linkage 30, 32; 130, 132; 230, 232 to at least one of the first mount member 24, 124, 224 and the second mount member 26, 126, 226.

The method 1000 can further include a step 1500 of molding the at least one elastically deformable joint 34, 36; 134, 136; 234, 236 as a monolithic piece of material with the linkage 30, 32; 130, 132; 230, 232 and at least one of the first mount member 24, 124, 224 and the second mount member 26, 126, 226 in a single molding operation.

The method 1000 can further include a step 1600 of molding the linkage 30, 32; 130, 132; 230, 232 and the at least one elastically deformable joint 34, 36; 134, 136; 234, 236 including a first elastically deformable joint 34, 134, 234, 234′ formed as a monolithic piece of material with the linkage 30, 32; 130, 132; 230, 232 and the first mount member 24, 124, 224 and a second elastically deformable joint 36, 136, 236 formed as a monolithic piece of material with the linkage 30, 132, 232 and the second mount member 26, 126, 226.

The method 1000 can further include a step 1700 of molding the first elastically deformable joint 34, 134, 234 and the second elastically deformable joint 36, 136, 236 having a plurality of elastically deformable members 44, 50 spaced from one another, each elastically deformable member 44, 50 having a linkage end 46, 52 fixed to the linkage 30, 32; 130, 132; 230, 232 and a mount end 48, 54 fixed to one of the first mount member 24, 124, 224 and the second mount member 26, 126, 226.

The method 1000 can further include a step 1800 of operably coupling the first mount member 24, 124, 224 to the second mount member 26, 126, 226 with a plurality of the at least one linkage 30, 32; 130, 132; 230, 232.

The method 1000 can further include a step 1900 of molding each of the plurality of linkages 30, 32; 130, 132; 230, 232 as a monolithic piece of material with a separate one of the at least one elastically deformable joint 34, 36; 134, 136; 234, 234′, 236 and molding the elastomeric deformable joints 34, 36; 134, 136; 234, 234′, 236 as a monolithic piece of material with at least one of the first mount member 24, 124, 224 and the second mount member 26, 126, 226.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hinge assembly for assisting in moving a pivotal closure member from a closed position toward an open position relative to a motor vehicle body and for releasably holding the closure member in the open position, the hinge assembly comprising:
a first mount member configured for operable connection to one of the closure member and the motor vehicle body;
a second mount member configured for operable connection to the other of the closure member and the motor vehicle body;
at least one linkage operably coupling the first mount member to the second mount member; and
at least one elastically deformable joint coupling the at least one linkage to at least one of the first mount member and the second mount member.

2. The hinge assembly of claim 1, wherein the at least one elastically deformable joint is a monolithic piece of material with the linkage and at least one of the first mount member and the second mount member.

3. The hinge assembly of claim 1, wherein the at least one elastically deformable joint includes a first elastically deformable joint formed as a monolithic piece of material with the linkage and the first mount member and a second elastically deformable joint formed as a monolithic piece of material with the linkage and the second mount member.

4. The hinge assembly of claim 1, wherein the at least one elastically deformable joint is a polymeric material.

5. The hinge assembly of claim 1, wherein the at least one elastically deformable joint includes a plurality of elastically deformable members spaced from one another, each elastically deformable member having a linkage end fixed to the linkage and a mount end fixed to one of the first mount member and the second mount member.

6. The hinge assembly of claim 5, wherein the plurality of elastically deformable members converge from the mount ends toward one another to the linkage ends.

7. The hinge assembly of claim 1, wherein the at least one linkage includes a first linkage operably coupling the first mount member to the second mount member and a second linkage operably coupling the first mount member to the second mount member, at least one of the first linkage and the second linkage including the at least one elastically deformable joint.

8. The hinge assembly of claim 7, wherein at least one of the first linkage and the second linkage includes a first elastically deformable joint formed as a monolithic piece of material with the linkage and the first mount member and a second elastically deformable joint formed as a monolithic piece of material with the linkage and the second mount member.

9. The hinge assembly of claim 7, wherein at least one of the first linkage and the second linkage includes a pivotable joint connection to at least one of the first mount member and the second mount member.

10. The hinge assembly of claim 7, further including at least one biasing member extending from at least one of the first mount member and the second mount member, the at least one biasing member engaging at least one of the first linkage and the second linkage to bias the closure member (12) from the closed position toward the open position.

11. A method of constructing a hinge assembly for assisting in moving a pivotal closure member from a closed position toward an open position relative to a motor vehicle body and for releasably holding the closure member in the open position; the method comprising:
forming a first mount member configured for operable connection to one of the closure member and the motor vehicle body;
forming a second mount member configured for operable connection to the other of the closure member and the motor vehicle body; operably coupling the first mount member to the second mount member with at least one linkage; and
molding at least one elastically deformable joint coupling the at least one linkage to at least one of the first mount member and the second mount member.

12. The method of claim 11, further including molding the at least one elastically deformable joint as a monolithic piece of material with the linkage and at least one of the first mount member and the second mount member and molding at least one of the at least one elastically deformable joint having a plurality of elastically deformable members spaced from one another, each elastically deformable member having a linkage end fixed to the linkage and a mount end fixed to one of the first mount member and the second mount member.
